(19) United States
(12) Patent Application Publication
(10) Pub. No.: US 2007/0186011 A1
(43) Pub. Date: Aug. 9, 2007

(54) INDUSTRIAL PROTOCOL AND GATEWAY

(75) Inventors: Brian A. Batke, Novelty, OH (US); Anatoly Moldovansky, Pepper Pike, OH (US); Gary W. Baczkowski, Seven Hills, OH (US)

Correspondence Address: ROCKWELL AUTOMATION, INC./(AT), ATTENTION: SUSAN M. DONAHUE, E-7F19, 1201 SOUTH SECOND STREET, MILWAUKEE, WI, 53204, US

(73) Assignee: ROCKWELL AUTOMATION TECHNOLOGIES, INC., Mayfield Heights, OH (US)

(21) Appl. No.: 11/536,334

(22) Filed: Sep. 28, 2006

Related U.S. Application Data
(63) Continuation-in-part of application No. 11/347,417, filed on Feb. 3, 2006.
(60) Provisional application No. 60/772,135, filed on Feb. 10, 2006.

(51) Int. Cl. G06F 15/16

(52) U.S. Cl. 709/246

(57) ABSTRACT

A gateway component for an industrial automation system is provided. This includes an agent component to process network interactions for a network device. An industrial protocol object facilitates interactions between an industrial automation component and the network device, where a mapping component translates between industrial control protocols associated with the industrial protocol object and network protocols associated with the agent component.

### CROSS REFERENCE TO RELATED APPLICATIONS

This application claims the benefit of U.S. Provisional Patent Application Ser. No. 60/772,135, filed on Feb. 10, 2006, entitled “INDUSTRIAL PROTOCOL ENABLED NETWORK SWITCH WITH INPUT/OUTPUT CAPABILITY”. This application is also a continuation-in-part of U.S. patent application Ser. No. 11/347,417, filed on Feb. 3, 2006, entitled “EXTENDING INDUSTRIAL CONTROL SYSTEM COMMUNICATIONS CAPABILITIES”. The entireties of these applications are incorporated herein by reference.

### TECHNICAL FIELD

The subject invention relates generally to industrial control systems and more particularly to a translation or gateway component between an industrial protocol and public communications protocol.

### BACKGROUND

In recent years, there has been a growing need to integrate industrial control systems across a plurality of different types of networks and protocols while maintaining communications performance of smaller or more-proprietary systems. One problem here is that often times a desired communication interface and required communications services do not match. For code compatibility, it may be desirable to use an existing industrial protocol interface, yet there is a need for higher level services, such as gateway functions, multicast or time synchronization, which generally are not available. In many cases, either the communication service interface need to be changed to a more full featured protocol or the existing protocol need be enhanced to support the required features.

Along with communicating on a desired network, consider the situation where a PLC desires to implement connectivity via an industrial network protocol. Newer protocols such as EtherNet/IP have a rich set of application-level objects as well as complex network protocol layers. A PLC implementing EtherNet/IP connectivity will find it useful to include application layer features (application objects). However, it is desirable not to require the PLC processor to implement the entire EtherNet/IP network layer. There are several current methods in which industrial protocol support is implemented in PLCs. Existing EtherNet/IP implementations, for example, generally implement the network and application layers in the PLC itself, using the backplane between the PLC and Network Interface Module as a network hop. For older and simpler protocols, PLCs often use a dual-port or memory-map interface between the PLC and Network Interface Module to transport the actual industrial protocol packets.

In one example of a previous industrial communications protocol, a Data Highway (DH) and Data Highway Plus (DH+) protocol have been employed to enable remote communications between a given PLC module and one or more remote communications devices. These protocols are generally associated with PCCC protocols which stand for “Programmable Controller Communications Commands. In some cases, these protocols have been used to control I/O devices operating in remote I/O racks. One example for achieving such control and communications has been to utilize what is known as a pass-thru function where remote I/O commands are sent though a DH or DH+ communications packet. In other words, a remote I/O command may be transported within a respective DH or DH+ communications command to control remote I/O functions. Although this type of communications has been successful in the past, it is noted that remote I/O protocols and the DH/DH+ protocols are related by a common industrial protocol. There is a need however to communicate between devices that employ non-related or disassociated protocols.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Systems and methods are provided to enable translations of industrial control protocols in accordance with common network management protocols. Such translations can occur in components such as a network switch or gateway where functionality of the network switch is controlled and monitored via commands or instructions associated with the industrial protocol. In one aspect, an industrial protocol object is embedded on a network switch or other devices and communicates via a mapping component to an agent component on the device. The controller object employs the industrial protocols to communicate with control systems components such as programmable logic controllers or other modules adapted for the industrial protocol. The mapping component translates commands such as output commands from the control components into network commands that can be employed by the agent to ultimately control functionality of the device such as enabling or disabling one or more ports on the device. Thus, the common network management protocol in one aspect acts as a transport medium for the industrial protocols, where control system status and commands are communicated via common input/output commands yet transported over common network management protocols associated with the network device.

The agent component is generally adapted for common network management protocols (network protocols distinguished from industrial protocols such as CIP) such as Ethernet although other network protocols can be employed. The agent component can receive status or requests from a manager component (e.g., SNMP manager), where such status and requests are translated into controller input data by the mapping component. The requests or status to the control system elements are then transported across the common network management protocol to the control system. When received, the controller can then examine input status for example to determine various aspects of the device or manager component such as diagnostics, alarms, unauthorized network access, performance data, quality of service data, and so forth.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a network switch for an industrial automation system.

FIG. 2 is a diagram illustrating example protocol mapping for a network switch.

FIG. 3 illustrates an example system that employs a formatted request/reply interface for a network switch.

FIG. 4 illustrates an example system that employs an encapsulated request/reply interface for a network switch.

FIG. 5 is a diagram illustrates an alternative mapping for a network switch.

FIG. 6 is a diagram illustrating a network switch for an industrial controller environment.

FIG. 7 illustrates an example network switch.

FIG. 8 illustrates example diagnostics for a network switch.

FIG. 9 illustrates example alarms for a network switch.

FIG. 10 illustrates a network mapping process for an industrial automation system.

### DETAILED DESCRIPTION

Systems and methods facilitate integration of industrial protocol objects with components of a network device where the industrial protocol objects communicate with various elements of a control system. A gateway component for an industrial automation system is provided. This includes an agent component to process network interactions for a network device. An industrial protocol object facilitates interactions between an industrial automation component and the network device, where a mapping component translates between industrial protocols associated with the industrial protocol object and common network management protocols associated with the agent component.

It is noted that as used in this application, terms such as “component,” “module,” “interface,” and the like are intended to refer to a computer-related entity, either hardware, a combination of hardware and software, software, or software in execution as applied to an automation system for industrial control. For example, a component may be, but is not limited to being, a process running on a processor, a processor, an object, an executable, a thread of execution, a program and a computer. By way of illustration, both an application running on a server and the server can be components. One or more components may reside within a process and/or thread of execution and a component may be localized on one computer and/or distributed between two or more computers, industrial controllers, and/or modules communicating therewith.

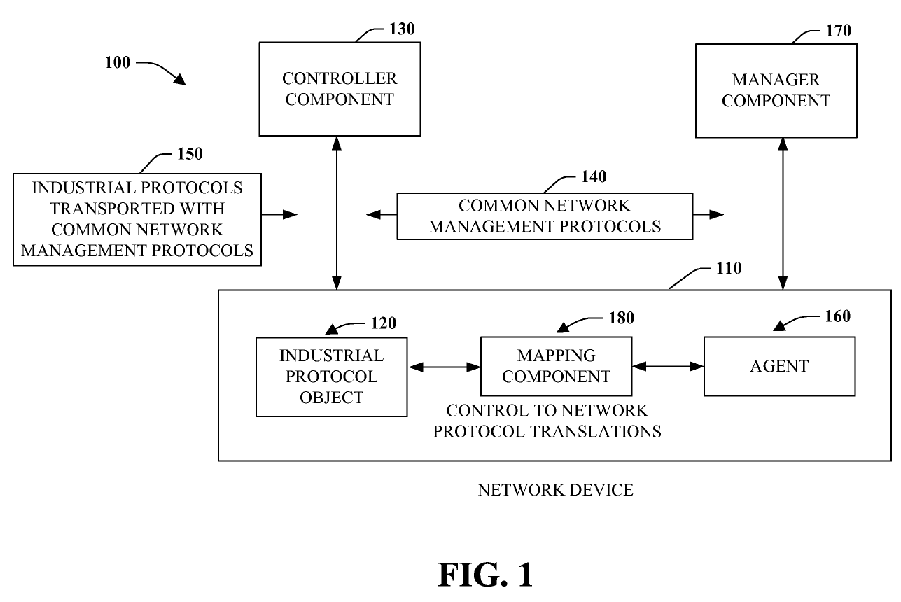

Referring initially to FIG. 1, a system 100 illustrates a network device 110 for an industrial automation system. The network device 110 (e.g., switch, gateway, network component) includes at least one industrial protocol object 120 that is generally responsible for processing/communicating via an industrial or factory protocol. An example of such protocol could include Control and Information Protocol (CIP), but other industrial or factory protocols (e.g., ModBus) can be employed. The industrial protocol object 120 supports communications with one or more controller components 130 which can include programmable logic controllers, communications modules, or intelligent modules adapted to communicate via an industrial protocol. In general, the network device 110 employs a common network management protocol 140 which is distinguished from an industrial protocol such as CIP. Such common network management protocols 140 can include public information protocols such as Ethernet yet other protocols are possible.

As illustrated at 150, the controller component 130 employs the common network management protocol 140 as a transport medium for the industrial control protocol supported by the industrial protocol object 120 in the device 110. It is noted that protocol mappings are bidirectional where in an alternative aspect, industrial control protocols 150 could be employed as a transport for the common network management protocols 140. Thus, output commands from the controller component 130 can be transported over the common network management protocols 140 to the device 110. Similarly, status from the device 110 can be communicated via input data associated with the industrial protocols of the controller component 130 and subsequently transported via the common network management protocol 140. The network device 110 generally includes an agent component 160 that supports communications to one or more ports (shown and described below), where the agent communicates with a manager component 170 via the common network management protocol 140. The manager component 170 provides status relating to operations of the device 110, and receives commands generated from the controller component 130. A mapping component 180 (or components) translates commands and status from the industrial control protocols of the controller component 130 to commands and status that can be interpreted by the network device 110 and in this case, the agent component 160.

As can be appreciated, various configurations can be employed for the industrial protocol object 120, the mapping component 180, and the agent 160. For example, the network device 110 could potentially support two common network management protocols 140, where a subset of network ports were devoted to one protocol and another subset of ports devoted to a second protocol 140. Thus, in this example, the mapping component 180 could map from the industrial protocols of the controller component 130 to one or more common network management protocols 140 associated with the device 110, where more than one agent 160 could be provided to support such protocols. In another example, the controller component 130 could support multiple protocols. In that instance, the mapping component 180 could map between at least two industrial protocol objects 120 and the common network management protocol of the agent 160. In still yet another example, multiple industrial protocols could be supported by the controller component 130 and multiple common network management protocols 140 supported by the device 110. Thus, at least two industrial protocol objects 120 could communicate to at least two agent objects 160, where multiple mapping components 180 could map between the respective protocols. As can be appreciated, a single mapping component 180 could be provided to translate between multiple protocols supported by the industrial protocol object 120 to the multiple protocols supported by the agent object 160.

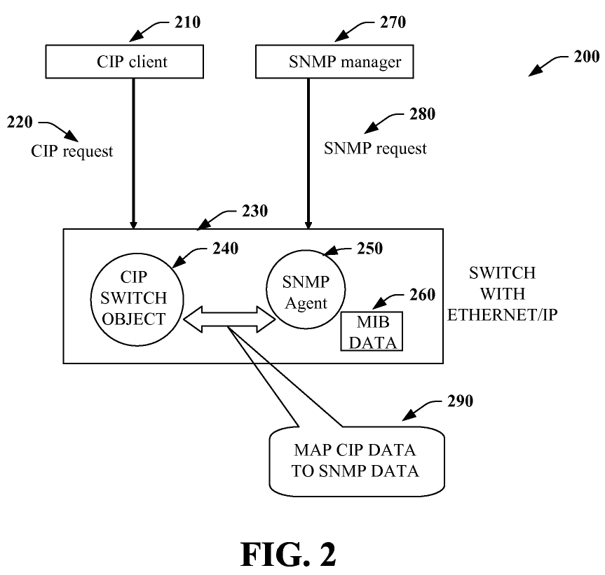

Referring now to FIG. 2, a system 200 illustrates example protocol mapping for a network switch or device. In this example, a CIP client 210 generates CIP requests 220 which are communicated to a switch 230 having Ethernet/IP capability. A CIP object 240 communicates to a Simple Network Management Protocol (SNMP) agent 250 associated with Management Information Base (MIB) data at 260. As illustrated, an SNMP manager 270 communicates with the switch 230 via SNMP requests 280, where one or more methods are provided at 290 to map CIP data to SNMP data and visa versa. The Simple Network Management Protocol (SNMP) is an application-layer protocol designed to facilitate the exchange of management information between network devices associated with the switch 230.

By using SNMP-transported data (such as packets per second and network error rates), network administrators can more easily manage network performance, find and solve network problems, and plan for network growth. The SNMP agents 250 are software components that reside in network elements such as the network switch 230. They collect and store management information such as the number of error packets received by a network element. Managed objects include a characteristic of an aspect that can be managed. For example, a list of currently active TCP circuits in a particular host computer can be a managed object. Managed objects differ from variables, which are particular object instances. Managed objects can be scalar (defining a single object instance) or tabular (defining multiple, related instances). The Management information base (MIB) 260 is a collection of managed objects residing in a virtual information store. Collections of related managed objects are defined in specific MIB modules.

The example system 200 provides a translation or gateway mechanism between an industrial protocol (e.g., CIP) and SNMP, for example. The CIP originator 210 (e.g., a controller) sends CIP messages 220 to retrieve and set variables in the switch 230. Variables in the CIP message 220 correspond to SNMP MIB variables at 260. The CIP message requests are then transformed at 290 in order to access the resident SNMP information at 260, where there are several possible methods at 290 by which the CIP-SNMP transformation (or other protocol transformation) can be achieved. It is noted that that mapping between protocols can go in both directions. For example, the SNMP manager 270 generates the SNMP request 280 that maps onto a CIP MIB 260, and then having a translation mechanism to map that onto a CIP service, class, instance, attribute (or in general, to the industrial protocol level constructs).

The system 200 addresses the general problem relating to embedding CIP or other industrial protocol and EtherNet/IP in industrial Ethernet switches 230. Embedding CIP in the switch 230 allows access of switch configuration and diagnostics via the controller at 210, and allows one to configure the switch from industrial programming software tools. In general, substantially any mechanism that ‘gateways’ or ‘translates’ CIP commands (or other industrial protocol) into the native command language or protocol of the switch 230 can be employed. For example, mapping can include CIP to SNMP, SNMP to CIP and so forth. This also includes encapsulating the ‘native switch language’ within CIP or other industrial protocol, thus providing an automatic gateway or translation.

Other aspects can include the use of electronic keying to identify the correct type and revision of the switch 230 and use of the industrial protocol to automatically deliver configuration to the switch. Switch configuration can be stored within the controller program for example. Configuration can also be pushed to the switch 230, or the switch can pull from the controller at 210 such as via an auto device replacement (ADR) function. A self describing object structure can be employed that allows for variable switch configuration parameter sets. This allows different parameters for different types of switches without having to define a new object each time. Configuration software can be provided with profiles that can read the self-describing switch object structure, create configuration screens, and then configure the switch 230. Also, alarms and events on the switch 230 can be delivered via the industrial protocol explicitly, or via a publish/subscribe mechanism, rather than via the I/O connection associated with the industrial protocol.

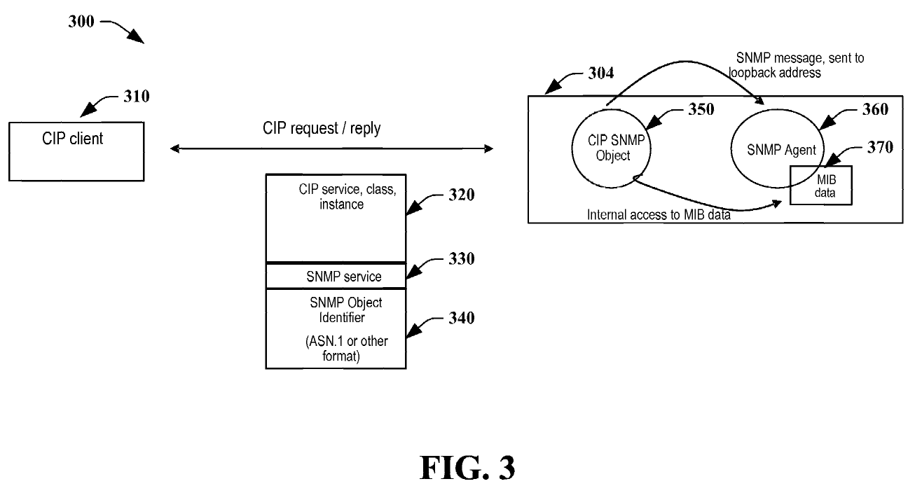

Referring to FIG. 3, an example system 300 illustrates a formatted request/reply interface for a network switch 304. In this aspect, an originator such as client 310 formats a CIP message 320 (or other industrial protocol) that identifies an SNMP (or other network protocol) variable to retrieve or set. The message 320 can include an SNMP service 330 and an SNMP object 340 describing one or more SNMP MIB variable(s). In one example, the object 340 can employ abstract syntax notation (ASN.1) to identify SNMP info (SNMP compatible), or a more compact format (more CIP compatible). As shown, a CIP object 350 employs the message 320 to communicate with an SNMP agent 360 which is associated with MIB data 370.

There are several mechanisms by which the CIP message 320 can be processed. In one case, the CIP object 350 in the switch 304, receives the incoming CIP message 320, constructs an SNMP message, and internally routes the SNMP message to the SNMP agent 360 (e.g., via loop-back IP address). In another case, the CIP object 350 in the switch 304 receives incoming CIP messages 320, translates into SNMP-compatible terms, then accesses the information available in an SNMP layer (not shown) via an internal application programming interface (API), memory location, and so forth. In yet another example, a communications module translates CIP to SNMP, and forwards it to the switch 304.

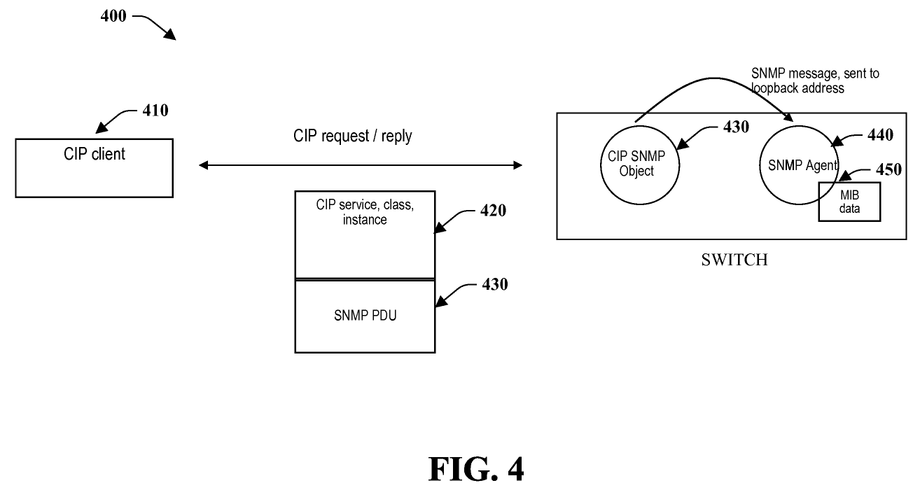

Referring to FIG. 4, an example system 400 illustrates an encapsulated request/reply interface for a network switch 404. In this example, an originator such as a client 410 formats a complete SNMP Protocol Data Unit (PDU) and encapsulates the data within CIP or other industrial protocol. An encapsulated message 420 is sent to a CIP object 430 that unwraps an SNMP PDU 440. This may entail less processing operations for the switch 404, but places more burden on the CIP originator 410, since it is now responsible for constructing and decoding SNMP PDUs. As with previous examples, the switch 404 includes an SNMP agent 440 having associated MIB data 450. Several options can be provided for processing the encapsulated message 420. In one example, the CIP object 430 in the switch 404 unwraps the SNMP message 420 from CIP and then internally routes the message to the SNMP agent 440. In another example, a communications module processes the incoming CIP message 420, unwraps the SNMP message, and sends it to the switch 404. The SNMP response can be encapsulated within CIP and sent to the originator at 410. Industrial programming software can be provided that can read the SNMP MIB 450 description and then ‘automatically’ generate user interface screens with SNMP variables including screens to process CIP messages and to get/set SNMP variables.

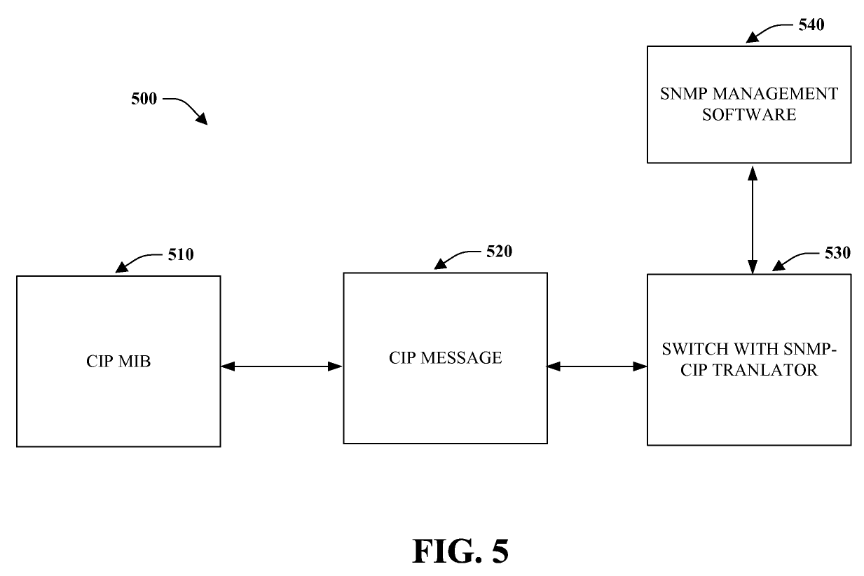

Referring briefly to FIG. 5, an alternative mapping system 500 is provided that can be employed with a network switch. In this aspect, a component for mapping SNMP requests to CIP object attributes is provided. At 510, this includes defining CIP MIB with objects and attributes representing leaves on a CIP MIB tree, for example. At 520, a component generates a CIP message from an SNMP request for the CIP MIB 510. At 530, an SNMP-to-CIP translation is provided on a switch, CIP device, or in a gateway module, for example. After performing the translation, the device 530 can be accessed via SNMP management software or other components.

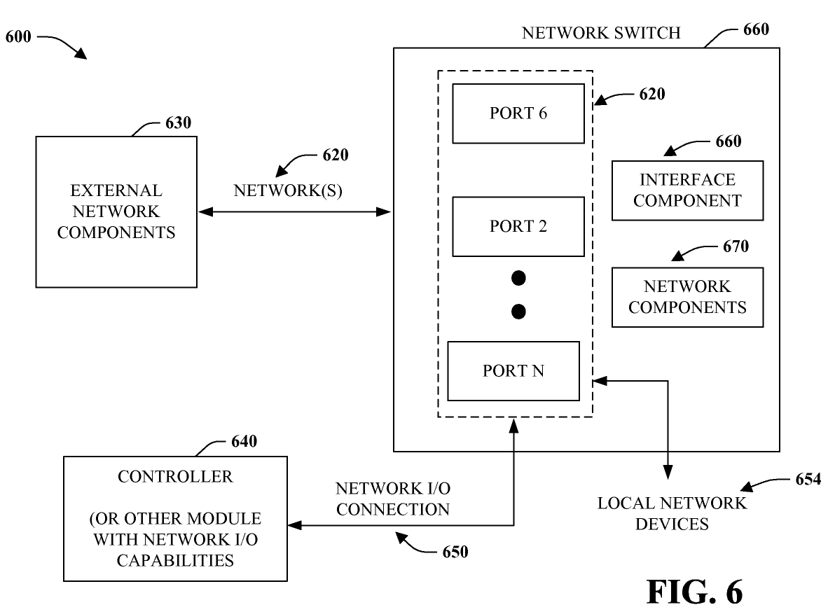

Referring to FIG. 6, a system 600 illustrates a network switch 610 for an industrial automation system. The network switch 610 includes one or more ports 620 that can be accessed across a network 624 from a plurality of external network components 620, where external implies outside the private network domain of a control system. A controller 640 employs a network I/O connection 650 in accordance with at least one of the ports 620 to control access of the network components 630 or other local network devices 654 to the control system. Access can be controlled by reading input status and controlling port access via input or output commands in the controller 640. An interface component 660 on the network switch 610 enables at least one of the ports 620 to appear as an input or output connection to the controller 640 such as a programmable logic controller (PLC). It is to be appreciated that substantially any device having network I/O capability can be employed in place of the controller 640 including communications modules or intelligent network modules, for example.

In one example, the interface component 660 may function as an adapter to the controller 640 providing suitable I/O protocols in conjunction with available network protocols that allows Ethernet communications (or other public domain network protocol) between the network switch 610 and the controller 640, yet the respective ports 620 of the switch are accessed and controlled from simple I/O commands of the controller. For example, an input can be read in a PLC data table location indicating status of the respective ports 620. Similarly, outputs can be set in the PLC data table that enable or disable operations of the ports 620. In this manner, interactions with the network switch 610 can be controlled by the controller 640 as opposed to relinquishing such control to the switch which may not facilitate an optimal remote access solution. As shown, the network switch 610 can include network components 670 or electronics that facilitate network connections between the external components 630, controller 640, and/or network devices 654.

To illustrate I/O capabilities of the network switch 610, inputs from a respective port 620 may indicate that an unauthorized MAC ID of an external network component 630 or local network device 654 is attempting to access the switch and ultimately the network on which the controller 640 resides. Depending on how the controller 640 processes the unauthorized MAC ID access, an output could be set in the controller's output table that effectively disables the port 620 where the unauthorized access occurred. In another application, the controller 640 may detect that a device has attempted access but given the nature of the access, time of day, process condition, or other programmed condition, the controller may ignore such access depending on logic programmed in the controller. This type of control is in sharp contrast to previous solutions where all decisions to enable or disable the switch 610 resided on the switch. With PLC control of the switch provided by the interface component 660 and I/O capability, remote access to the control system can be managed in a more effective manner. Also, by providing simple I/O interface capabilities on the network switch 610, interfacing between external networks 630, the switch 610, and the respective controller 640 can be greatly simplified since complex networking interfaces associated with prior switch configurations no longer need be interfaced by the control system.

As will be described in more detail below, the network switch 610 can provide a plurality of capabilities that facilitate remote network management of control systems. This includes enhanced diagnostic capabilities to aid in determining interactions with the control system, straight-forward and easy configuration screens for the switch, and other switch management interfaces. Other aspects include, persistent real-time data connections between the switch 610 and controller 640 which includes the ability to enable or disable the ports 620 using the real-time connection. Diagnostics are facilitated across such connections including the ability to receive alarms, unauthorized MAC ID status via the real-time connection, general health or condition of the switch, and the ability to configure the switch to permit MAC ID management.

Before proceeding, it is noted that the components 630 or 654 can include various computer or network components such as servers, clients, programmable logic controllers (PLCs), communications modules, mobile computers, wireless components, control components and so forth which are capable of interacting across the network 624. Similarly, the term PLC as used herein can include functionality that can be shared across multiple components, systems, and or networks 624 or 650. For example, one or more PLCs can communicate and cooperate with various network devices across the network 624 or connection 650. This can include substantially any type of control, communications module, computer, I/O device, sensor, Human Machine Interface (HMI)) that communicate via the network which includes control, automation, and/or public networks. The PLC can also communicate to and control various other devices such as Input/Output modules including Analog, Digital, Programmed/Intelligent I/O modules, other programmable controllers, communications modules, sensors, output devices, and the like.

The ports 620, and network connections 624, 650, 654, can include protocols for public networks such as the Internet, Intranets, and automation networks such as Control and Information Protocol (CIP) networks including DeviceNet and ControlNet. Other networks include Ethernet, DH/DH+, Remote I/O, Fieldbus, Modbus, Profibus, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

In addition to various hardware and/or software components, various interfaces can be provided to manipulate the switches 610 where various examples are illustrated in more detail below. This can include a Graphical User Interface (GUI) to interact with the switch 610 or other components including any type of application that sends, retrieves, processes, and/or manipulates data, receives, displays, formats, and/or communicates data, and/or facilitates operation of the system 600. For example, such interfaces can also be associated with an engine, server, client, editor tool or web browser although other type applications can be utilized.

The GUI can include a display having one or more display objects (not shown) for manipulating the switch 610 including such aspects as configurable icons, buttons, sliders, input boxes, selection options, menus, tabs and so forth having multiple configurable dimensions, shapes, colors, text, data and sounds to facilitate operations with the switch. In addition, the GUI can also include a plurality of other inputs or controls for adjusting and configuring one or more aspects. This can include receiving user commands from a mouse, keyboard, speech input, web site, remote web service or other device such as a camera or video input to affect or modify operations of the GUI.

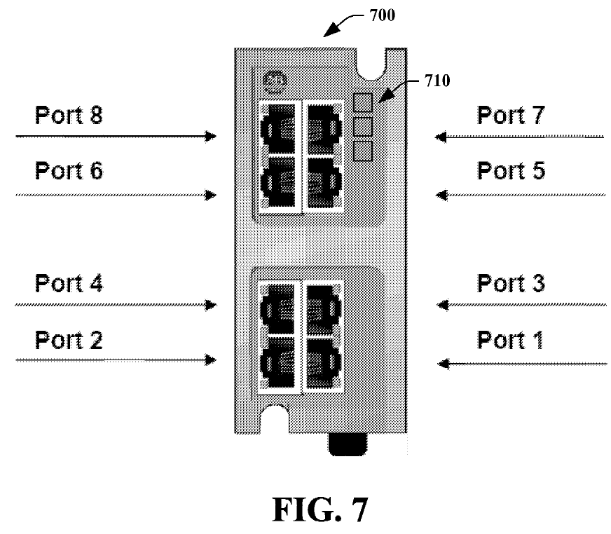

Referring briefly to FIG. 7, an example switch configuration 700 is illustrated. As shown, the switch 700 includes eight network ports however more or less than eight can be provided. At 710, one or more status LED's can be provided on the switch 700. It is noted that the ports are marked 1 though 8 where even ports are on one side and odd port numbers on the other. It is to be appreciated that other port numberings are possible. The switch 700 houses the objects, agents, and other components described above for the respective translation, control, and communication aspects of the switch. Before proceeding, one or more of the following definitions may be employed with a network switch:

UDP—Defined by RFC 1122, section 4.1: The User Datagram Protocol offers a minimal transport service. UDP is used by applications that do not require the level of service of TCP or that desire to use communications services (e.g., multicast or broadcast delivery) not available from TCP. An application program running over UDP interacts directly with end-to-end communication problems that a connection-oriented protocol would have handled. This is commonly observed with I/O type devices that will send out information at an RPI rate.

TCP—Transmission Control Protocol, TCP enables two hosts to establish a connection and exchange streams of data. TCP guarantees delivery of data and also guarantees that packets will be delivered in the same order in which they were sent.

DNS—(Domain Name Server) Translates domain names into IP addresses, for example www.example.com may translate to 192.168.100.100.

DHCP—(Dynamic Host Configuration Protocol) Commonly used on office networks. Scarce IP address space is efficiently used because IP addresses are “leased” to clients for a limited time. This lease concept facilitates the recycling of addresses, which is the heart of DHCP.

Bootp—(Bootstrap Protocol) Commonly used with AB Ethernet products, defined by RFC 951, BOOTP protocol is used by a client machine to locate its IP address and network mask.

Domain—A group of computers and devices on a network that are controlled as a unit with common rules and procedures.

IGMP Definition—the switch can include a feature referred to as IGMP snooping. In one aspect, IGMP snooping can sort multicasting devices into groups. This can limit the multicast packets received by hosts that do not need the information, thus making the network more efficient and deterministic. When it is not used, other devices may be slowed down by the continuous flow of UDP packets. IGMP can be configured by enabling it and setting a version and query period. The Query period determines how often a network is queried for Group information, the hosts on the network will respond with their group information. To observe multicast groups, an IGMP report can be generated and located under a “Diagnostics” folder interface.

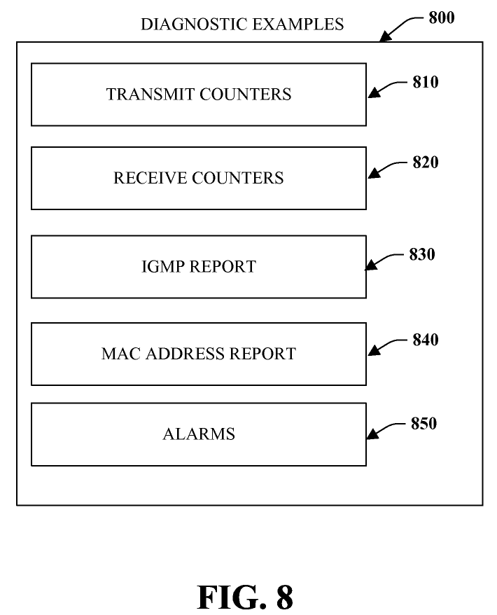

FIG. 8 illustrates various diagnostic aspects for a network switch. At 810, one or more transmit (TX) counters can be provided. TX counters include: Tx Octet Count—Total of transmitted good octets from the selected port; Tx Drop Pkts Count—Packet is not acknowledged by the receiving host; Tx BroadcastPkts Count—Number of good packets sent w/destination of end devices. Receivers are unspecified; Tx MulticastPkts Count—Packets sent to members of multicast group. One terminal to many hosts; Tx UnicastPkts Count—In contrast with multicast, consist of one terminal transmitting to one host; Tx Collisions Count—Two terminals transmit packets at the same time causing them to collide, Collision Count should be low, where collisions could indicate a faulty device on the network; Tx SingleCollision Count—Packet collides with one other terminal's transmitted packet; Tx MultipleCollision Count—Packet collides with more than one terminal's transmitted packets; Tx DeferredTransmit Count—Number of packets delayed because the network is busy (Higher the number the less deterministic the network); Tx LateCollision Count—Collision is detected later than the 512 bits into the packet transmittion, cable may be too long (100 meters 10/100 baseT limit), repeating hubs on the network; Tx ExcessiveCollision Count—Packets not transmitted because the packet experienced 16 failed attempts, usually indicates bad cabling or connecters; Tx FrameInDisc Count—Network Device is not acting in compliance with a flow control request; Tx PausePkts Count—Pause frames sent by this port. At 820, one or more receive (RX) diagnostic counter can be provided. Receive counters include: Rx Octets—Total good octets received on selected port; Rx Undersize Pkts—Acceptable packets that are under 64 octets long; Rx Pause Pkts—Pause packets received by this port; Pkts64Octets—Data packets=512 bits; Pkts65to127 Octets—Data packets=520-1016 bits; Pkts128to255 Octet—Data packets=1024-2040 bits; Pkts256to511 Octet—Data packets=2048-4088 bits; Pkts512to1023 Octet—Data packets=4096-8184 bits; Pkts1024to1522 Octet—Data packets=8192-12176 bits; RxOversize Pkts—Packets over 12176 bits or 1523-1536 Octets; RxJabbers Pkts—Packets longer than 1522 Octets, and have an error, usually caused by a faulty network adapter card on the network; RxAlignment Errors—Packets between 64 and 1522 octets, and have an error. Excessive alignment errors usually indicate a speed mismatch between the port and the connected device.

Other receiver diagnostics 820 include: RxFCS Errors—Packets received (between 64-1522 octets) with FCS (frame check sequence) not matching. Could be caused by a speed mismatch between the port and the connected device; RXGoodPkts—Octets received with no errors; RxDrop Pkts—Packets dropped due to lack of resources (bandwidth, input buffer); RxUnicast Pkts—Unicast packet received (1 receiving host); RxMulticast Pkts—Multicast packets received (many receiving hosts); RxBroadcast Pkts—Received by all hosts on the network; RxSAChanges—Number of times the Source address of a good packet has changed value. A count greater than 1 indicates a repeater based network; RxFragments—Packets received less than 64 octets that have an FCS or alignment error. Usually caused by collisions; RxExcessSizeDisc—Packets received greater than 1536 octets and discarded due to excessive length. Usually caused by a faulty driver; RxSymbolError—Ethernet uses Manchester encoding to encode data as symbols before transmission over the physical media. The destination reverse encodes the symbols back into data. Some code symbols are invalid and are disallowed.

At 830, an IGMP report can be provided. An IGMP protocol adds a group number to a transmitted packet. Generally, only hosts in that IGMP group will receive the packet. The IGMP protocol prevents a multicast packet from acting like a broadcast (transmitted to all network hosts). The switch manages the task of forming a table of IGMP groups and hosts belonging to those groups. At 840, a MAC Address Report can be provided. All Ethernet equipment has a MAC address (hardware address). These can be displayed by selecting Diagnostics>MAC address report. A pool of MAC addresses are assigned to each Ethernet product manufacturer. At 850, an alarms status can be provided and configuration thereof will be described below.

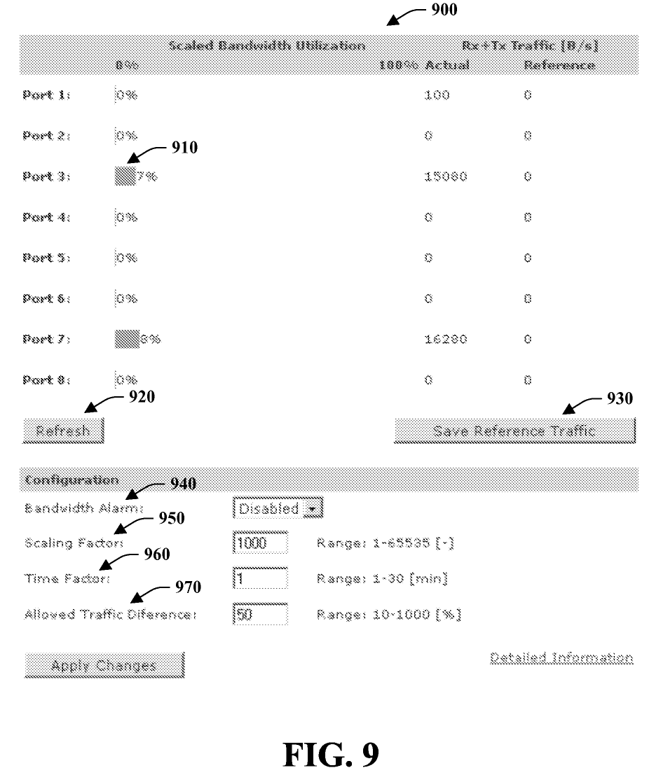

FIG. 9 illustrates an example alarm configuration interface 900 for a network switch. The interface 900 can be used to observe bandwidth on each port. For example, a bar 910 turn red (from green) when the bandwidth is out of range. At 920, a refresh selection is used to refresh the interface 900 with the latest information, where the interface can automatically refresh at the rate configured under Basic Configuration>Refresh Rate. At 930, a Save Traffic Reference is employed as a benchmark for the system network. Click this button 930 when the network is running as it should in production. The switch can calculate the difference between the reference point and the current levels of traffic for each port. If it varies to an alarm state, it can send an input to the PLC indicating the port number.

At 940, a Bandwidth Alarm configuration is disabled by default, and when enabled will calculate the difference between the reference point of the network and the current rate of traffic. If a variation, exceeding the allowed traffic difference, occurs it sends an input to the PLC indicating the port number that the bandwidth issue is occurring. At 950, a Scaling Factor configuration is provided. Most applications can have such a small amount of traffic that the bandwidth will only be a fraction of a percent. The scaling factor adjustment 950 allows a more visual representation of the traffic on each port. Scaling Factor can also be changed from the PLC using an input word. At 960, a Time Factor configuration relates to the length of time packets are counted to determine the bandwidth percentage for each port. At 970, an Allowed Traffic Difference includes the percentage that the current traffic level can vary in either direction, from the stored reference value, before an input is sent to the PLC.

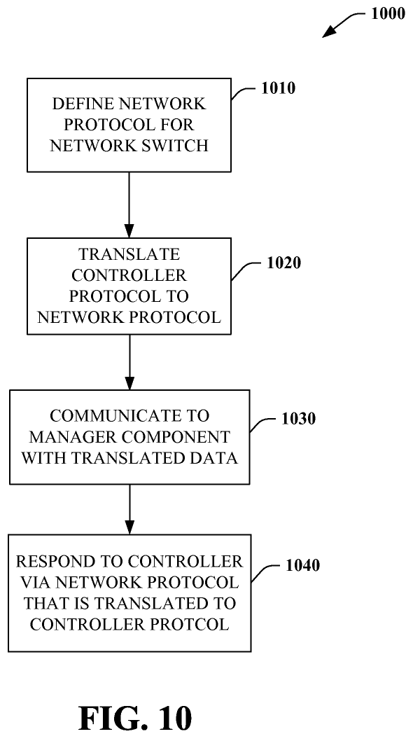

FIG. 10 illustrates a network translation process 1000 for an industrial automation system. While, for purposes of simplicity of explanation, the methodology is shown and described as a series of acts, it is to be understood and appreciated that the methodology is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as described herein.

Proceeding to 1010 of FIG. 10, a network protocol is defined for a network switch. This can include substantially any type of protocol that enables devices external or local to the control system to have network access to the control system via the switch. In a common example, the network protocol includes Ethernet but other network protocols including Simple Network Management Protocol (SNMP) are possible. This can include providing an SNMP agent to process the network protocol. At 1020, a controller I/O protocol is translated to the network protocol defined above at 1010. In essence, the control protocol (e.g., CIP) is transported over the network protocol to a controller or other module having industrial protocol capabilities, where in addition to the network communications, the controller can also communicate to the switch via controller input and output data table locations or other CIP construct. Thus, the switch ports can appear as an I/O module to the controller in one example (similar to I/O in the rack with the controller) even though the inputs and outputs are transported within the confines of the network protocol defined at 1010.

At 1030, after translation, communications can commence with network objects such as a network manager described above. The network manager communicates in a language native to the manager without concern for the underlying control protocols that generated a specific request to the manager. At 1040, the manager or other network component responds to the controller via the switch. Similar to the translation at 1020, a translation occurs that maps the manger components response which is in accordance with a network protocol to a control protocol suitable for a control component.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A gateway component for an industrial automation system, comprising:
an agent component to process network interactions for a network device;
an industrial protocol object to facilitate interactions between an industrial automation component and the network device; and
a mapping component to translate between industrial control protocols associated with the industrial protocol object and network protocols associated with the agent component.

2. The gateway component of claim 1, further comprising a module to read inputs or write outputs associated with the industrial control protocols.

3. The gateway component of claim 1, the module is a programmable controller, a communications module, or an intelligent module.

4. The gateway component of claim 1, the network protocols are associated with an Ethernet protocol or a TCP/IP protocol.

5. The gateway component of claim 4, the industrial control protocols are associated with a Control and Information Protocol (CIP).

6. The gateway component of claim 4, the network protocols are associated with a Simple Network Management Protocol (SNMP).

7. The gateway component of claim 1, the agent component is associated with Management Information Base (MIB) data object.

8. The gateway component of claim 7, the agent component communicates with at least one external SNMP manager.

9. The gateway component of claim 7, further comprising a component to translate an SNMP request to an industrial protocol construct.

10. The gateway component of claim 7, further comprising an abstract syntax notation to identify the MIB variable.

11. The gateway component of claim 1, the mapping component receives a CIP message, constructs an SNMP message, and routes the SNMP message to the agent component.

12. The gateway component of claim 1, the mapping component employs an application programming interface to communicate with an SNMP layer.

13. The gateway component of claim 1, the mapping component decodes data from an encapsulation message where at least one protocol is encapsulated within at least one other protocol.

14. The gateway component of claim 13, the encapsulation message is associated with an SNMP Protocol Data Unit (PDU).

15. The gateway component of claim 14, further comprising a component to unwrap the encapsulation message and route the message to an SNMP agent.

16. The gateway component of claim 14, further comprising a CIP object that is employed as part of an SNMP request.

17. The gateway component of claim 1, the industrial control protocol is employed to enable or disable one or more ports or configuration items associated with the network device.

18. The gateway component of claim 17, the industrial control protocol and the network protocol are employed to provide diagnostics for the network switch.

19. The gateway component of claim 18, the diagnostics provide status from at least one alarm condition.

20. The gateway component of claim 19, the alarm condition is associated with at least one of a bandwidth alarm, a scaling factor, a time factor, and an allowed traffic difference.

21. The gateway component of claim 20, the scaling factor is associated with a scaled bandwidth utilization component.

22. The gateway component of claim 18, the diagnostics include one or more transmit counters, one or more receive counters, an IGMP report, and a MAC address report.

23. A computer readable medium having a data structure stored thereon to facilitate network translations in an industrial automation environment, comprising:
a first data field to specify a network protocol associated with at least one public network;
a second data field to specify an industrial controller protocol; and
a third data field that specifies a message for the industrial controller protocol, the message identifies variables associated with the network protocols.

24. The computer readable medium of claim 23, the network protocol is an Ethernet protocol.

25. The computer readable medium of claim 24, the Ethernet protocol is associated with an SNMP protocol.

26. The computer readable medium of claim 23, the message is associated with at least one of an SNMP service or an SNMP object identifier.

27. The computer readable medium of claim 23, the message is associated with an encapsulation protocol.

28. The computer readable medium of claim 27, the encapsulation protocol is associated with an SNMP Protocol Data Unit.

29. A method to translate data for an industrial control system, comprising:
providing at least one controller object to process an industrial protocol;
providing an agent object to process a network protocol; and
mapping at least one variable from the industrial protocol to the network protocol.

30. The method of claim 29, further comprising mapping at least one variable from the network protocol to the industrial protocol.

31. The method of claim 29, further comprising providing network status via the industrial protocol.

32. The method of claim 29, further comprising providing network diagnostics via the industrial protocol.

33. A network device for an industrial control system, comprising:
means for generating at least one network protocol;
means for transporting at least one industrial protocol in accordance with the network protocol; and
means for mapping data between the industrial protocol and the network protocol.
